(19) United States
(12) Patent Application Publication
(10) Pub. No.: US 2007/0114275 A1
(43) Pub. Date: May 24, 2007

(54) NOVEL ENHANCED QUASI-PERSONALIZED DATA SET PRODUCTS AND PROCESSES

(76) Inventor: Jeffrey C. Joy, Coto de Caza, CA (US)

Correspondence Address: GREENBERG TRAURIG LLP, 2450 COLORADO AVENUE, SUITE 400E, SANTA MONICA, CA, 90404, US

(21) Appl. No.: 11/538,686

(22) Filed: Oct. 4, 2006

Related U.S. Application Data
(60) Provisional application No. 60/723,670, filed on Oct. 4, 2005.

(51) Int. Cl. G06K 5/00

(52) U.S. Cl. 235/380

(57) ABSTRACT

At least one of a card, product, key-chain fob, or any other tangibly manifested item or related mechanism is provided whereby a user can store a specific data set or predetermined order which is then scanned, read or otherwise interpreted at a point-of-purchase location and debited off of/or otherwise reduced from a stored balance on the device, for use at point-of-purchase transactions, whereby the quasi-personalized data, or quasi-customized information allows a purchasing or related transaction to be more efficient, faster, more expediently run or simply better for the retail establishment consumer or both. Gift-cards housing pre-ordained selections of goods, services or a particular type of item (eg. shoes) are likewise contemplated.

### CROSS REFERENCE TO RELATED APPLICATIONS

This application claims the priority benefit of, and full Paris convention Priority rights from U.S. Provisional Patent Application 60/723,670. Said application was filed by the present inventor on Oct. 4, 2005, and is expressly incorporated herein by reference as if fully set forth herein.

### BACKGROUND

1. Field of the Invention

The present invention relates to processes and business methods for enabling consumers to more readily make purchases of pre-selected menu items at point-of-purchase or retail establishments, for example, at stores of their choice. In particular, the present invention teaches processes and methods for leveraging technological efficiencies for consumer convenience. The present disclosure relates to the arraying of quasi-personalized data on “store” or retail, gift, debit, and credit-types of cards, key-chains, fobs and related apparatus capable of storing machine readable data. In particular the instant disclosure improves extant systems for retail purchasing convenience by including a user's preference, or preferred order on a gift card, or any other product used at the point-of-purchase for a user's stored crediting, or debiting ability, to facilitate acquisition or purchase of goods and services.

The present invention provides another tool to allow an average consumer to use existing technology for rapid processing of payments and time savings, which addresses and overcomes longstanding needs.

2 General Background

Within the last decade, the generation of consumer-driven retail convenience has reached unprecedented levels. Among the purveyors of customer incentive awards and gift cards, a new species has arisen—the privately-labeled “store” type of card. These cards generally sport logos or related indicia which serve to identify the purveyors of goods or services and serve to promote brands and brand imagery. Since the cards generally can be loaded with at least one of cash and credit balances, they function as quasi-credit cards, often requiring re-loading with such balances.

These quasi-credit cards generally enable consumers to purchase, for themselves or others, small dollar amounts to store on the cards to use at retail establishments. By way of example each of the STARBUCKS®, BORDERS® and DIEDRICHS® brands of “store” types of cards may be found in Orange County, Calif. 92626. (See FIG. 2).

Needless to say, those who are engaged in other activities generally require both efficiency and convenience in the point-of-purchase type of transactions. A serious limitation of the extant systems has to do with their lack of capacity to store more personalized pieces of information, or data sets, pieces, bits, bites, arrays, typical or standardized order selections or other agglomerations known to those skilled in the art.

For example, as one joins a line of consumers at major, en-franchised coffee shops, if one-half of a dozen customers are ordering, each one must specifically recite their order, and the private-label cards they often use provide no relief from this conundrum. Time and other losses result from the delays, not to mention tensions and frustrations.

Accordingly, there is a longstanding need for a way to improve the efficiency of such “store” type or “gift-card” type apparatus or related systems to take a consumer's desired, or usual purchase or standard orders, for which such items are used often on a daily basis. Likewise, a “gift-card” type of device with a pre-ordained item, value or set of items is expressly contemplated to be within the scope of the instant teachings.

### SUMMARY OF THE INVENTION

According to a feature of the present invention there is provided, in a private-label gift or credit card for retail use, a stored ordering preference for selections chosen from a menu, inventory and array of store pricing or store inventory data.

According to another feature of the present disclosure there is provided a process for using quasi-personalized or quasi-custom data for point-of-purchase activities, which comprises, in combination, providing at least one of an article, product, card or related apparatus which can hold data, further comprising at least credit/cash/or related media of exchange information comprising a supplemental data set, loading the supplemental data set, including at least a personalized data set onto the same, such as a preferred order, the cost of the same or related information, presenting a resulting loaded article for purchase or other related activities at an established site for the same, for example a retail establishment, reading the data, having the data accessed, including the medium of exchange data as needed, subtracting or debiting or otherwise removing a desired amount from the stored medium of exchange data, based upon the supplemental data set and, repeating the process as needed, or any steps of the same.

According to another feature, there is provided a method for promoting a private label (either retail or wholesale) sales point by providing a data receptacle for acquiring such data. The data will then be readily portable to load data specific to a user on the data receptacle and then to present the data receptacle at a sales point, reading the data and debiting a desired balance from the data receptacle.

Briefly stated, a card or related mechanism is provided whereby a user can store a specific data set or predetermined order which is then scanned, read or otherwise interpreted at a point of purchase location and debited off of the stored balance on the device. Gift-cards housing pre-ordained selections of goods, services or a particular type of item (eg. shoes) is likewise contemplated.

### DRAWINGS

The above-mentioned features and objects of the present disclosure will become more apparent with reference to the following description taken in conjunction with the accompanying drawings wherein like reference numerals denote like elements and in which:

FIG. 1 is a flow-chart showing steps which are used according to an embodiment of the teachings of the present invention;

FIG. 2 shows an exemplary manifestation of a typical device which is enhanced to hold a specific item of personal data for a user according to the teachings of the present invention; and

FIG. 3 shows Internet-type and web portal based interfacing according to teachings of the present invention.

### DETAILED DESCRIPTION OF THE INVENTION

The present inventor has discovered that a longstanding need can be solved by emplacing customer data on any storage medium presentable at a point-of-purchase, such as a private label retail story type of card.

For the purposes of this specification, “quasi-customized”, “quasi-personalized” and “quasi-custom” are defined by a stored memory document housing at least one selection chosen from a menu or listing of prices or item sub-components or choices for a consumer to make. The present inventor has discovered that novel enhanced systems can incorporate enough personal data to heighten the efficiency of private-label and other retail-specific cards, among other things.

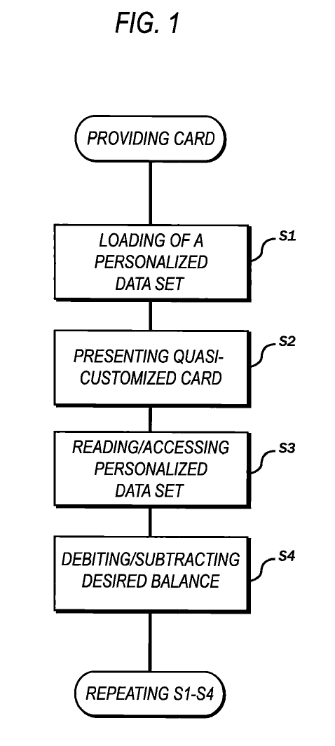

Turning now to FIG. 1 there is shown a progression of steps whereby embodiment of the present disclosure are defined. A first step S1 involves loading a personalized data set, for example in keeping with the coffee-shop discussions, a particularized order for a selection which is available on a retail basis (e.g., a cappuccino-type of coffee without foam), or one's usual preference or order.

A second step S2, includes presenting the card or related device at an establishment, as discussed above, generally a point-of-purchase type of interaction. For example, one enters the coffee-shop and presents the card, having a large strong coffee of the day, stored thereupon, or enter, stores and uses any desired item.

Those having a modicum of skill in the art understand readily that this includes any device, product, or other tangible manifestation upon which quasi-customized or quasi-personalized data may be stored, such as a key chain, fob or other article which it is convenient to carry around, sprayed, scanned, etched, finished or other after developed generations of readable or machine readable indicia.

Step S3 involves having the data read, or having the retail/point-of-purchase site access the personal data information, for example, that the user once again wishes to order a certain beverage or food item from the coffee shop. Those skilled in the art will readily understand linkages to network computers, the Internet, other web-based portals and wired and wireless hook-ups or expressly customized by the teachings of the present invention.

Step S4 involves debiting/subtracting cash, credit or any manner of value points from the product, device or article appropriately to reflect the acquisition or purchase of the desired pre-programmed item. This could be done on a credit/cash or any other basis known the those skilled in the art for such transactions. ATM, and other machines also work with the instant invention.

An additional or optional step involves operating of at least one of S1-S4, as many times as needed, likewise other predetermined programs and settings may be imported to govern this. Computers may be used to re-load, adjust, add, subtract or reconcile balances.

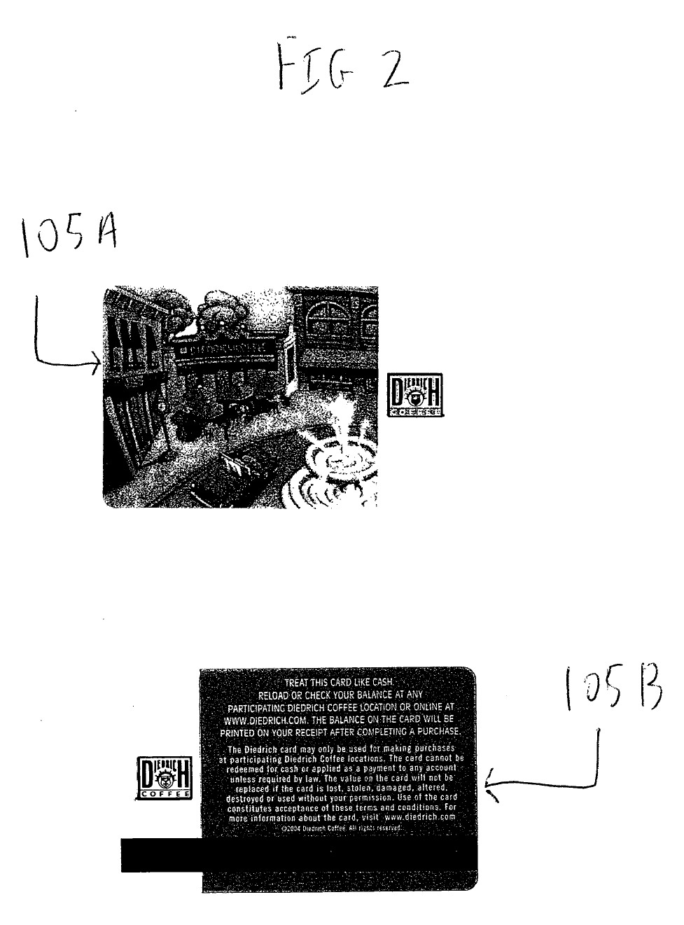

Referring now to FIG. 2, exemplary and illustrative embodiment of a quasi-personalized card 105A (front) and 105B (back) is shown in schematic fashion. Such a card may, for example, be purchased at any known retail establishment. For example, DIEDRICHS® Coffee House, Laguna Hills, Calif. 92691.

One example according to the teachings of the present invention would be a card purchased on a “gift-card” basis from a coffee shop. According to this example, one could purchase a predetermined number of selections linked to one's preferred order. So, if one wished to purchase—for example 30 of one's preferred coffee-drinks at $1.50 per drink, one could load this card with $45.00.

Likewise, this could be done for others. Upon scanning or otherwise reading the card the coffee shop would know what the desired order was, and debit or subtract the appropriate amount from the card.

Those skilled in the art generally understand that conventional electronic payment and debit systems are expressly incorporated herein by reference as if set forth fully herein.

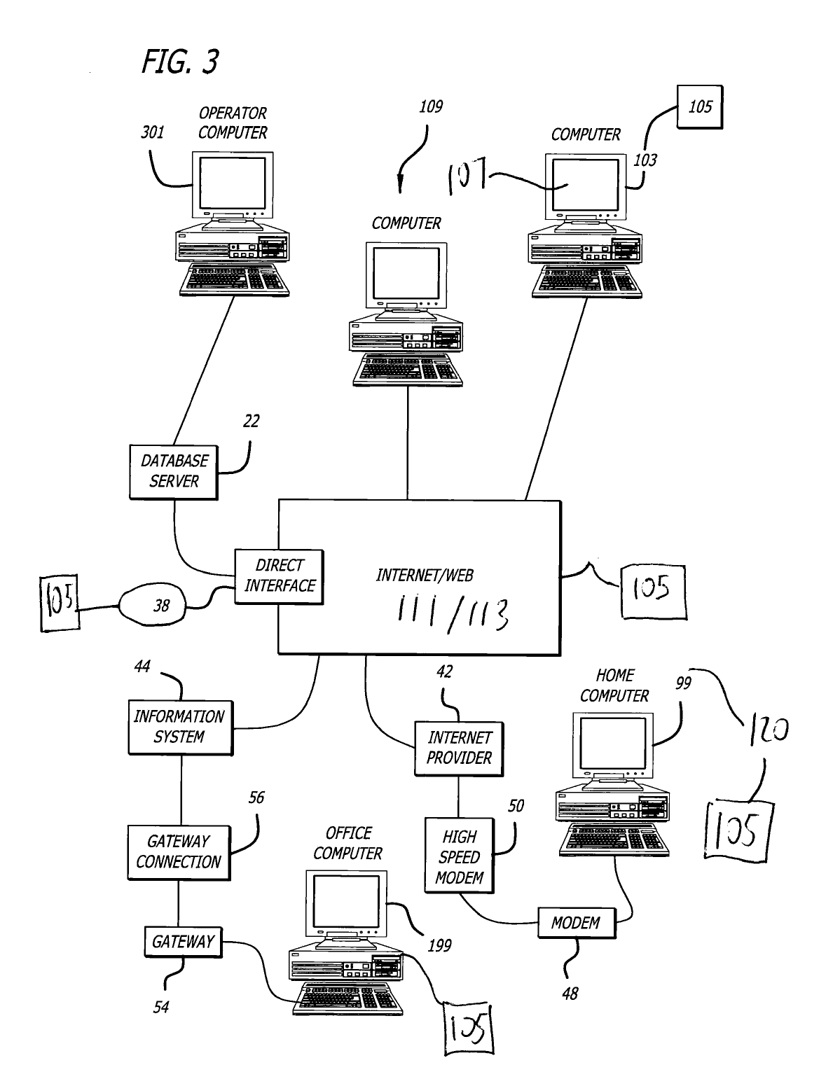

Referring now to FIG. 3, those skilled in the art readily comprehend how using appropriate reading and interfacing equipment quasi-personalized card 105 can be linked to any general purpose computer 107 through a home-based interface unit 103, which may link directly to the Internet 111, or the world-wide-web® 113. Likewise, personal data sets may be stored on computer 109 and delivered or updated via Internet 111 or the world-wide-web® 113.

FIG. 3 also shows operator computer 301, linked through database server 22 by direct interface or alternate router 38 to access quasi-personalized card 105. Gateway connection 56 links with information system 44 and gateway 54 or ISP 42, high speed modem 50, or conventional modem 48 each may provide a way to load quasi-custom card 105, using office computer 199 or home computer 99 and have interface 120. Those skilled understand readily how electronic transactions function, so further description is omitted. Point-of-purchase, or any retail establishment may be represented by operator computer 301, as many and interchangeable devices known to artisans.

According to the instant teachings electronic and Internet, and web-based protocols may link users and consumers to the status of their accounts, allow for payment, adjustments and additional transaction records and confirmatory.

As illustrated, the teachings of the present invention provide for unprecedented consumer convenience and comfort and accordingly constitutes progress in the science and the useful arts.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A process for using at least one of quasi-personalized and quasi-custom data for point-of-purchase activities, which comprises, in combination:
providing at least one of an article, product, card and related apparatus which can hold data, further comprising at least one of credit, cash, and related media of exchange information in addition to a supplemental data set;
loading a supplemental data set, including at least a personalized data set onto the same, such as at least one data element selected from the group consisting of a preferred order, the cost of the same, linking data, and consumer information mapped to at least one of a particular establishment, location and brand;
presenting a resulting loaded article for purchase of a desired item at an established site for the same, for example a retail establishment;
reading the supplemental dataset, having the supplemental dataset accessed; and,
subtracting debiting or otherwise removing a desired amount from the stored medium of exchange data, based upon the supplemental data set; and
repeating the process as needed, or any steps of the same.

2. A product, which functions according to the process of claim 1.

3. A product, according to claim 2, further comprised of at least one member from the group of store type of cards which comprise of a gift card, a point-of-purchase retail card, a private labeled credit or debit type card and a coffee-shop card.

4. A method for promoting a private label sales point comprising providing a data receptacle for acquiring data and being readily portable;
loading data specific to a user on said data receptacle;
presenting said data receptacle at said sale point; and
reading said data and debiting a desired balance from said data receptacle.

5. The process of claim 4, said data specific to a user comprising a desired selection from a menu of items available at the sales point.

6. A business process for brand promotion using a quasi-custom card-like element which comprises, in combination:
providing a branded card-like element, effective for storing at least one of an order and a usual preference and a selected item defining a personalized data set;
accessing said personalized data set and subtracting at least one of a desired balance and another predetermined aliquot.

7. The process of claim 6, further comprising repeating of at least one steps of said claim.

8. The process of claim 7, further comprising use of the Internet to facilitate at least one step of the process.

9. The process of claim 6, wherein the accessing stop occurs at a retail establishment.

10. The process of claim 9, said retail establishment further comprising at least one of a coffee-shop, a restaurant, an apparel shop, a service station and a point-of-purchase vendor of other goods and services.
